(19) United States
(12) Patent Application Publication
(10) Pub. No.: US 2004/0044561 A1
(43) Pub. Date: Mar. 4, 2004

(54) Commercial vehicle customer economic value tool

(76) Inventors: Cynthia Marshall Kolb, Chicago, IL (US); Vipul Shah, Westmont, IL (US); Bradley Bray, Needham, MA (US); Heather Karki, Ashland, MA (US); John Bloomer, Hopkinton, MA (US); Joseph Zale, Boston, MA (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/365,863

(22) Filed: Feb. 13, 2003

Related U.S. Application Data
(60) Provisional application No. 60/356,495, filed on Feb. 13, 2002.

(51) Int. Cl. G06F 17/60

(52) U.S. Cl. 705/10

(57) ABSTRACT

A commercial vehicle customer economic value computer software tool that directs a sales representative of commercial vehicles to query and input salient information about a customer, the customer's market or application, business model, and needs. Things included in this set of queries would include the number of invoices per unit time, the revenue per load or trip and the number of breakdowns normally experienced. This also includes how many miles per trip and trips per unit time with the miles per year and servicing needs being derived numbers from this input. The program outputs a solution or set of solutions with comparisons to competitor vehicles and services. The solution is a customer economic value estimate that provides a comparison of the sales representatives' product with competitors. The program narrows the choices in the next sequential portion of the evaluation. Also provided with the final estimate are a set of strategies for the specific customer's values and stated needs in comparison to the solution comparisons.

This document claims priority of provisional patent application serial No. 60/356,495, filed Feb. 13, 2002.

### BACKGROUND

This invention relates to a sales tool computer program for use by a salesperson in the sale of commercial vehicles to a customer. The tool helps sales representatives: better understand the customer or prospect's business and important business needs; create a product and service offering that best meets those needs; understand and explain how the offering is different from competitors; understand and explain the value of these differences to the customer; and create an account strategy that reinforces this value delivered and compels the customer to recognize this value as well.

### PRIOR ART

Sales representatives of non-commercial or passenger vehicles generally work with a homogenous customer base when it comes to needs and vehicle usage plans. On the other hand sales representatives of commercial vehicles have a heterogeneous customer base. Commercial vehicle usage varies widely and as such the customers' needs vary widely. As a result sales representatives for commercial vehicles are faced with a severe challenge in determining what will appeal to and be right for one customer would not appeal to or be right for another customer. With all the choices of different functionality and brands available, many times the customers really did not know options features or even what type vehicle and drive train suited their application. While prior art commercial vehicle sales representatives may have used computer sales tools, these tools were limited to the demonstration of or listing of features with the customer being responsible and having the latitude to select these features. This may be fine where the buyer is a sophisticated fleet customer who is buying hundreds of commercial vehicles such as trucks and buses every year. The problem arises where the customer is a small business or an independent driver that or who buys at most one truck or commercial vehicle every year or two. What has not been previously suggested is having a commercial vehicle customer economic value computer software tool in which the specific customer is queried on his or her specific business, usage, and intended applications and the sales representative is output a vehicle solution that includes an analysis of the customers' needs and the potential savings in services, engine overhaul, resale value, preventive maintenance costs in comparison to published data on like competitors.

### SUMMARY

The commercial vehicle customer economic value computer software tool of this invention satisfies the primary objective of this invention as follows. The program directs the sales representative to query and input the customers market or application. Included in this is what type of business, commercial or government. The program ties the application and type vehicle to a model and engine previously designed for that type business and application. The tie is made from a predetermined matrix. This type model and engine is stored for access upon gathering of additional information. The program directs the sales representative to query and input the customers' values or objectives when purchasing a commercial vehicle. Some examples would be that the customer's concern is that he or she saves money in the long term whether it is within the initial price or savings in usage or maintenance or overhaul costs or some combination. Another example would be a customer who wants the smallest initial purchase price up front. Another example, although probably not that common is a customer is not concerned about initial cost or maintenance and upkeep costs. The program ties this customer value determination to specific delineated strategies that are within a matrix within the program. This portion of the program may determine whether the customer is a previous purchaser and what is preferred. The program directs the sales representative to query and input information related to the customer business' revenue and costs. Things included in this set of queries would include the number of invoices per unit time, the revenue per load or trip and the number of breakdowns normally experienced. This also includes how many miles per trip and trips per unit time with the miles per year and servicing needs being derived numbers from this input. The revenue per load would be tied to the specific load. If the customer transported computer chips, this number would vary from a customer who transports diamonds, rare metals, or concrete. The program directs the sales representative to query and input the customers' needs for a vehicle in regards to warranty, need for a sleeper or vehicle-sleeping compartment among other functionality or services. The program outputs a solution or set of solutions with comparisons to competitor vehicles and services. The output is derived from a table by table matrix comparison of potential services, engine overhaul requirements on the vehicles and drive trains being compared, resale values from tables using model and years and providing cross check values, and preventive maintenance costs based upon published manufacturers recommended service requirements. The solution is a customer economic value estimate that provides a comparison of the sales representatives' product with competitors. Also provided are a set of strategies for the specific customer's values and stated needs in comparison to the solution comparisons.

### DRAWINGS

Other objects and advantages of the invention will become more apparent upon perusal of the detailed description thereof and upon inspection of the drawings, in which:

FIG. 1 is a logic diagram for a commercial vehicle customer economic value computer software tool made in accordance with this invention.

FIG. 2 is an example market/application information collection screen for the customer economic value tool of FIG. 1.

FIG. 3 is a customer information collection screen for the customer economic value tool of FIG. 1.

FIG. 4A is an example buyer characteristic data chart accessible from a screen for the customer economic value tool of FIG. 1.

FIG. 4B is a continuation of FIG. 4A.

FIG. 5 is an example revenue/components information form screen for the customer economic value tool of FIG. 1.

FIG. 6 is an example of vehicle information for comparison screen for the customer economic value tool of FIG. 1.

FIG. 7 is an example solutions screen for a user to select applicable services for the customer economic value tool of FIG. 1.

FIG. 8 is an example calculation details screen for replacement parts for particular vehicle comparison screen for the customer economic value tool of FIG. 1.

FIG. 9 is an example calculation details screen for preventive maintenance for particular vehicle comparison screen for the customer economic value tool of FIG. 1.

FIG. 10 is an example data display screen for a particular competitor under a comparison such as shown in FIG. 9.

FIG. 11 is an example view estimate screen for the customer economic value tool of FIG. 1 for a particular competitor comparison.

FIG. 11A is a continuation of FIG. 11.

FIG. 12 is a process diagram for one embodiment of a commercial vehicle customer economic value computer software tool made in accordance with this invention.

### DETAILS OF INVENTION

The commercial vehicle customer economic value computer software tool of this invention satisfies the primary objective of this invention as follows. The program directs the sales representative to query and input the customers market or application. Included in this is what type of business, commercial or government. The program ties the application and type vehicle to a model and engine previously designed for that type business and application. The tie is made from a predetermined matrix. This type model and drive train is stored for access upon gathering of additional information. The program directs the sales representative to query and input the customers' values or objectives when purchasing a commercial vehicle. Some examples would be that the customer's concern is that he or she saves money in the long term whether it is within the initial price or savings in usage or maintenance or overhaul costs or some combination. Another example would be a customer is wants the smallest initial purchase price up front. Another example, although probably not that common is a customer is not concerned about initial cost or maintenance and upkeep costs. The program ties this customer value determination to specific delineated strategies that are within a matrix within the program. This portion of the program may determine whether the customer is a previous purchaser and what makes have been preferred. The program directs the sales representative to query and input information related to the customer business' revenue and costs. Things included in this set of queries would include the number of invoices per unit time, the revenue per load or trip and the number of breakdowns normally experienced. This also includes how many miles per trip and trips per unit time with the miles per year and servicing needs being derived numbers from this input. The revenue per load would be tied to the specific load. If the customer transported computer chips, this number would vary from a customer who transports diamonds, rare metals, or concrete. The program directs the sales representative to query and input the customers' needs for a vehicle in regards to warranty, need for a sleeper among other functionality or services. The program outputs a solution or set of solutions with comparisons to competitor vehicles and services. The customer provides the competitor but the program then narrows the list of competitor models to the predetermined list of that specific competitor that are the analogous model of the ones offered by the sales representative. The output is derived from a table by table matrix comparison of potential services, engine overhaul requirements on the vehicles and engines being compared, resale values from tables using model and years and providing cross check values, and preventive maintenance costs based upon published manufacturers recommended service requirements. The solution is a customer economic value estimate that provides a comparison of the sales representatives' product with competitors. Also provided are a set of strategies for the specific customer's values and stated needs in comparison to the solution comparisons.

In one embodiment, the program may provide estimates on relative costs depending on whether the customer is financing or leasing the vehicle and provides on screen result of each option within these choices.

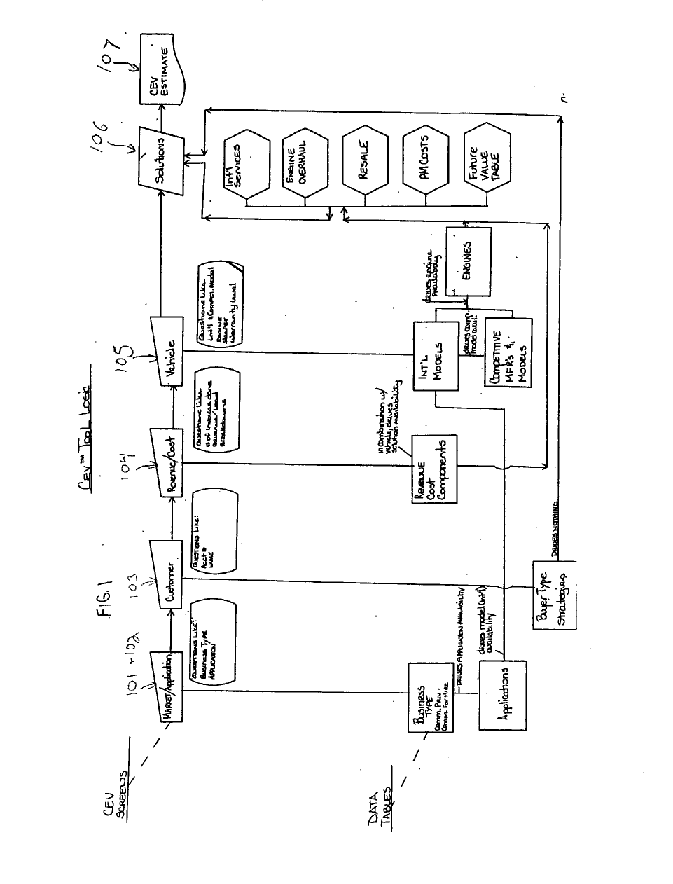

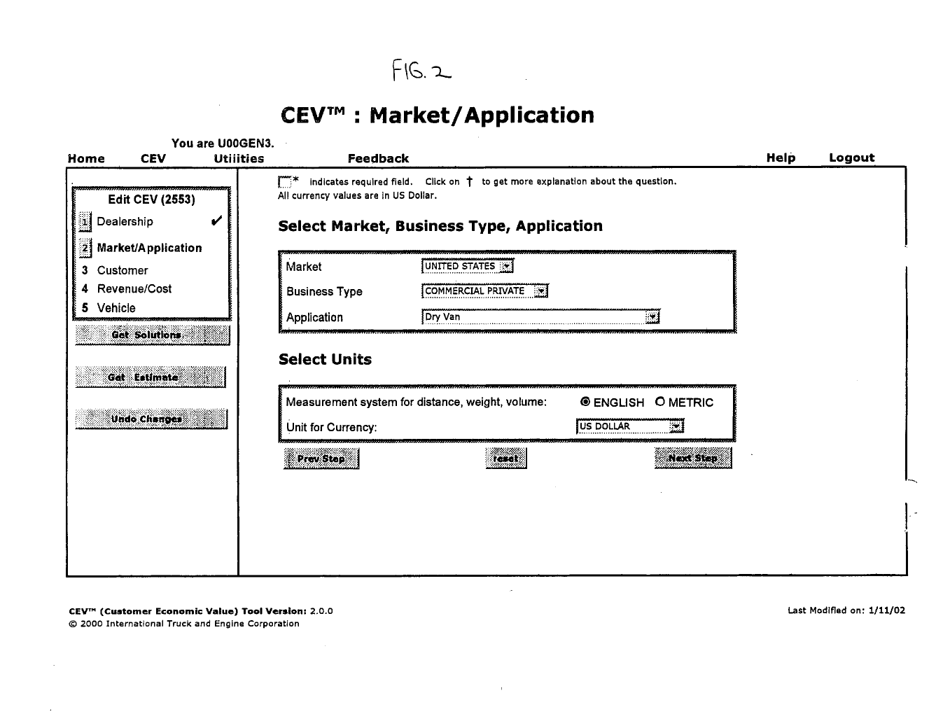

The program uses the tables or matrixes to narrow the choices in a particular customer economic value estimate. For instance the choice of a type of business will narrow the list of potential applications. The choice of a particular application will in turn limit the subsequent choice of models. The choice of model will limit the choice of competitor vehicles for comparison and the choice of model will limit the drive train or engine choices. FIG. 1 shows this narrowing effect as does the example customer economic value estimate shown in FIGS. 2 to 11A.

One feature is the side bar that allows users to quickly and easily navigate through their existing CEV™ (customer economic value) Estimates. The user can change the answer to any questions and, thru the side bar, quickly see the results on the Solutions screen without paging thru multiple screens each time. The questions are divided into four short screens: Market/Application, Customer, Revenue Cost, and Vehicle. There are Interview Guides located under Utilities on the Menu Bar. The required fields are still highlighted in yellow and marked with an asterisk. Another feature to the CEV™ Tool is application-based logic, like Sales Tools, to create a more unified approach to vehicle sales. In the Market/Application screen, the user selects a business type and market to accurately identify the applicable and appropriate models. The Customer screen features a logic called Buyer Type. A matrix is available to assist the user in accurately determining the customer's buyer type. The Buyer Type is tied into newly updated negotiation strategies and tactics offered in the Solutions screen. There is a feedback mechanism available on the Menu Bar. This is the users opportunity to give feedback and improve the CEV™ Tool as well as suggest questions for the Interview Guides.

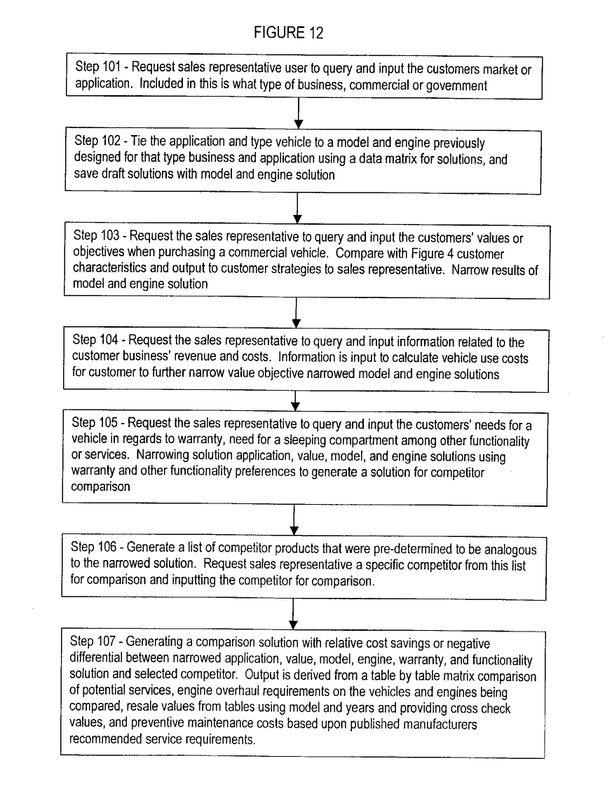

One embodiment of the process of this invention is shown in FIG. 12. In Step 101, the sales representative is asked to query the customer's market or application. FIG. 2 is an example of a market/application query screen that the system may present to the sales representative. The query may include business type that may include the options of commercial or government. The application query could include a number of alternatives including but not limited to dry vans, tow trucks, dump trucks, fire engines, ambulances, recovery vehicles, and concrete mixers.

In Step 102, the program ties the application and type vehicle to a set of model and engine solutions using a pre-loaded data matrix for solution. The program saves the model and engine solutions.

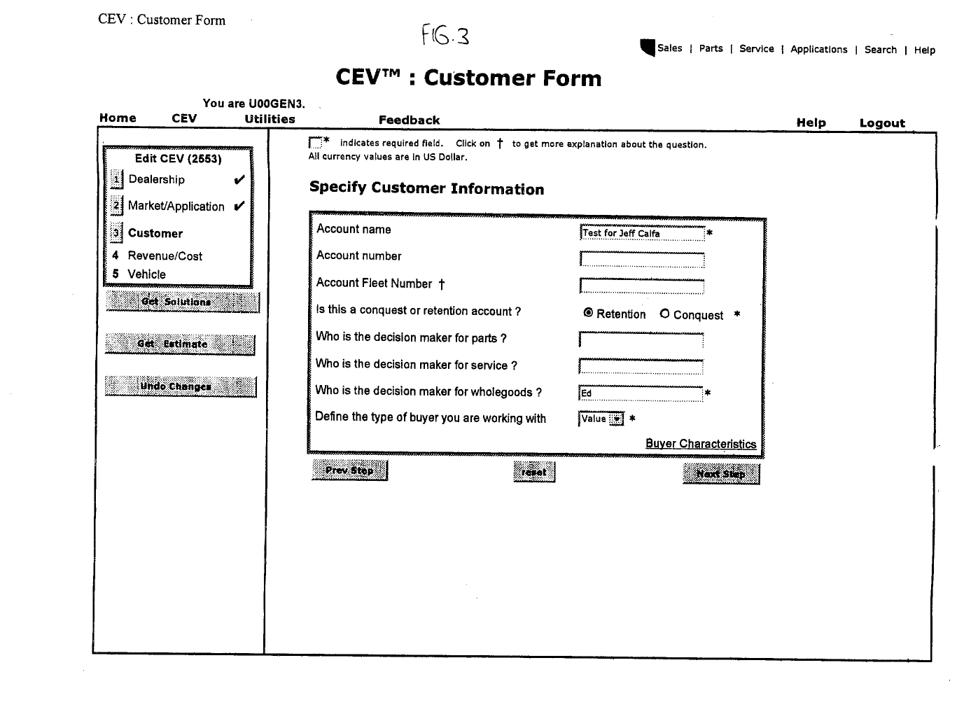

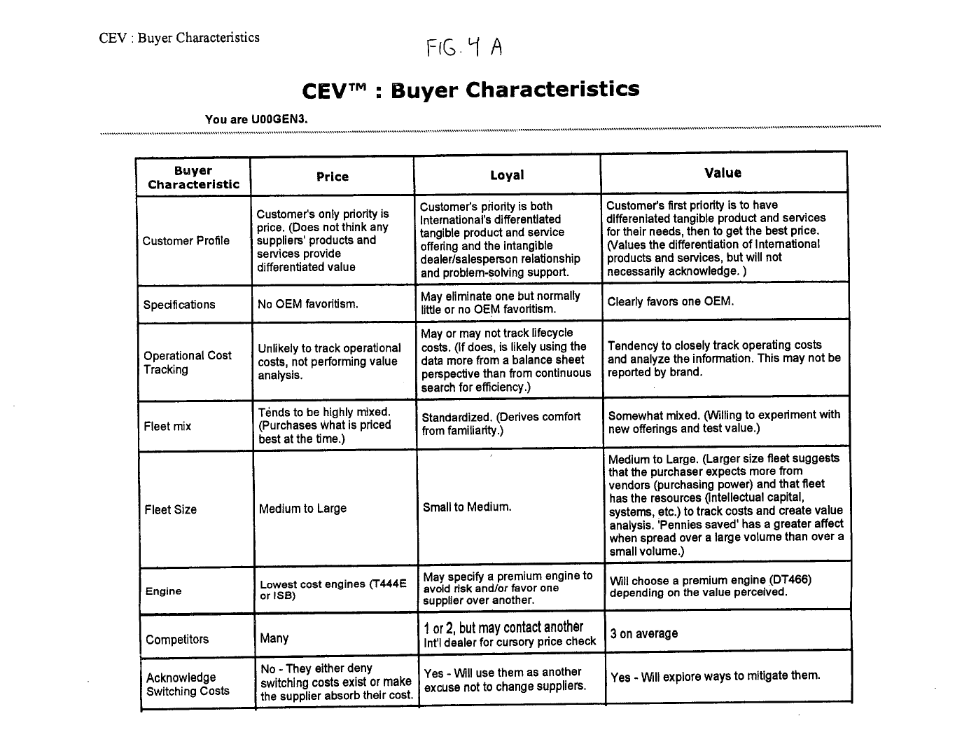

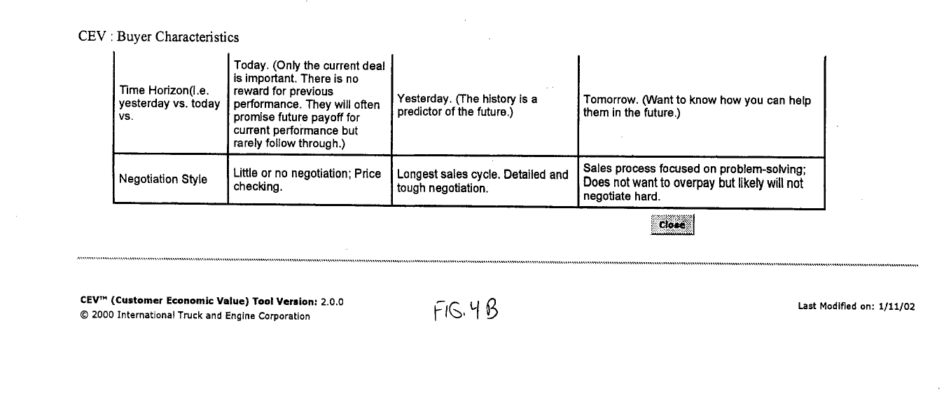

In Step 103, the sales representative is asked to query and input the customers' values or objectives when purchasing a commercial vehicle. The system compares the customer's values and objectives with the FIGS. 4A and 4B matrix of customer characteristics and outputs customer strategies to the sales representative. An example of the customer information screen is shown in FIG. 3. This data further narrows the results of the model and engine solution.

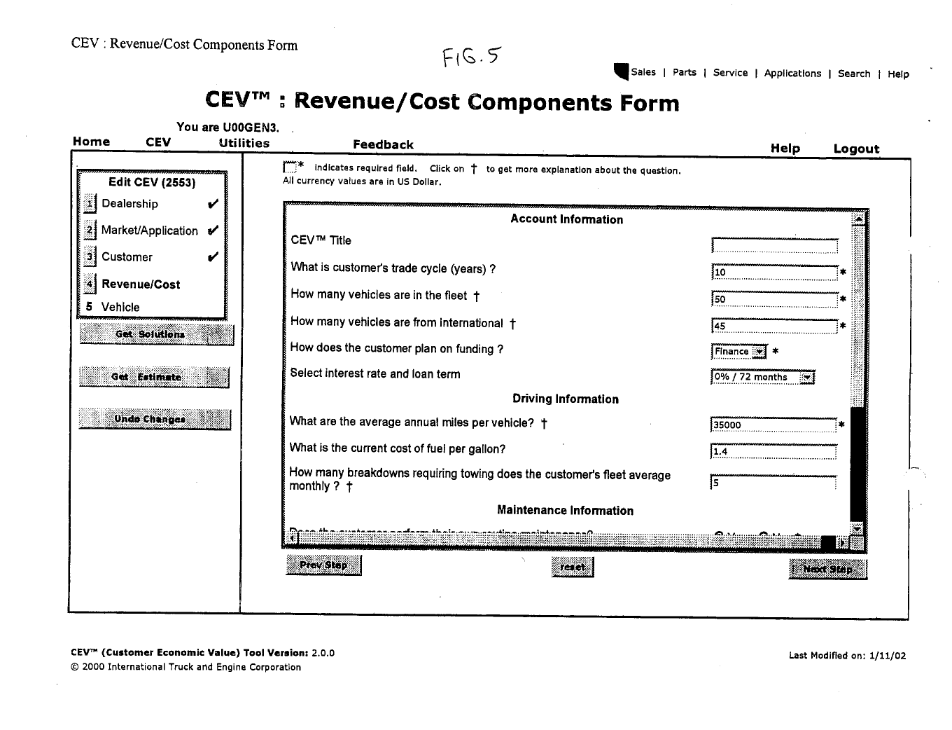

In Step 104, the sales representative is requested to query and input information related to the customer business' revenue and costs. Information is input for the process to calculate vehicle use costs for customer to further narrow value objective narrowed model and engine solutions from the value, model, and engine narrowed result. An example screen for querying and inputting this revenue and cost information is shown in FIG. 5. Some of the data includes how many vehicles are being used by the customer, how many miles are driven per vehicle, the cost of fuel, and the number of breakdowns per month. The system will use this data to calculate the customer's costs of operation.

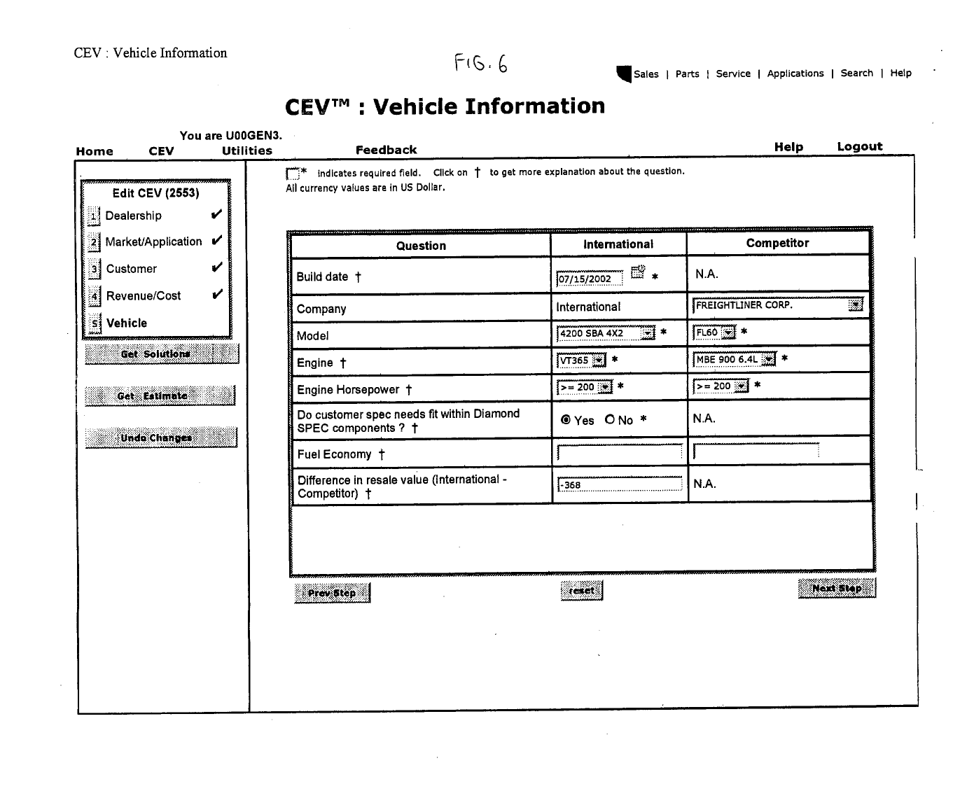

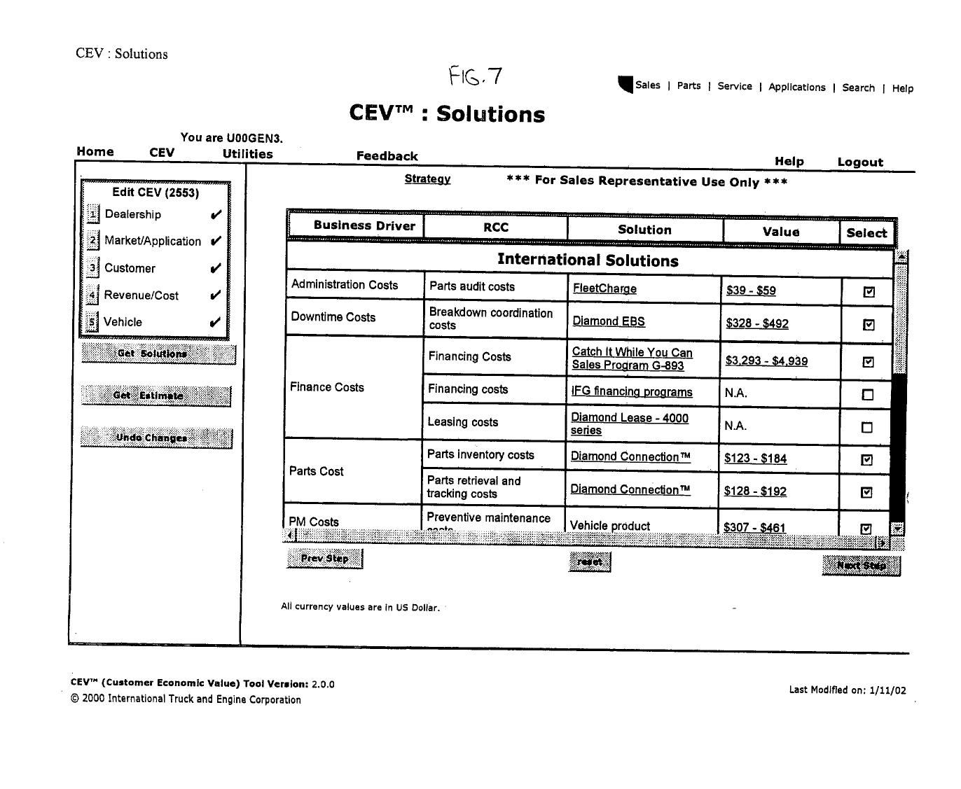

In Step 105, the sales representative is requested to query and input the customers' needs for a vehicle in regards to warranty, or the need for a sleeping compartment among other functionality or services. The warranty and functionality preferences are used to narrow the solution application, value, model, and engine solutions to generate a solution for competitor comparison. This is accomplished by comparison to matrix information related to suitability and capability. FIG. 7 shows warranty and service solutions for customer selection to drive the queries of Step 105. FIG. 6 shows the output of solution application, value, model, engine, as well as warranty and other functionality preferences. This solution is shown in the International® column, although the column could as well be labeled “own” or other brand name.

In Step 106, the system generates a list of competitor products that are analogous to the narrowed value, model, engine, and other functionality solution. These are shown in the competitor column of FIG. 6. The sales representative is prompted to have the customer select a customer product from the generated competitor list and to select such competitor product.

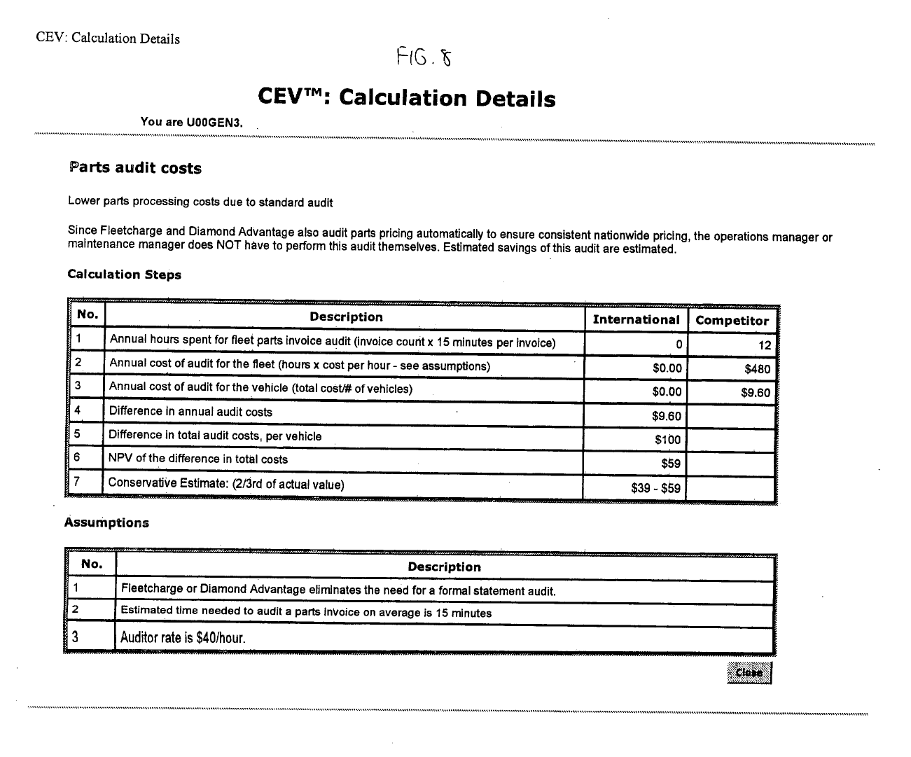

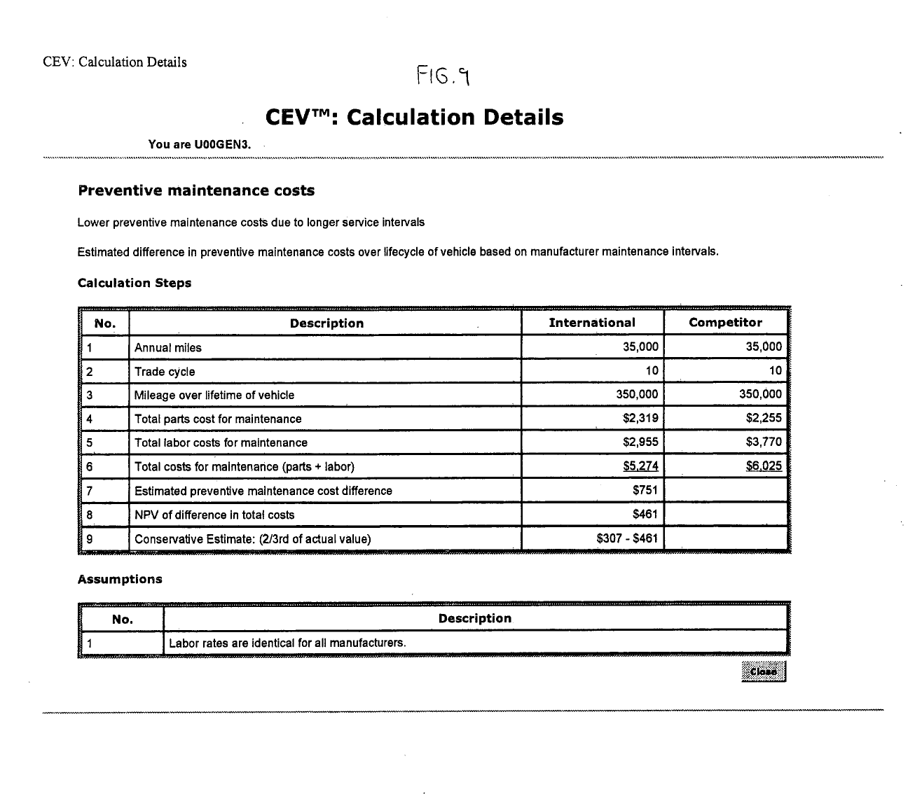

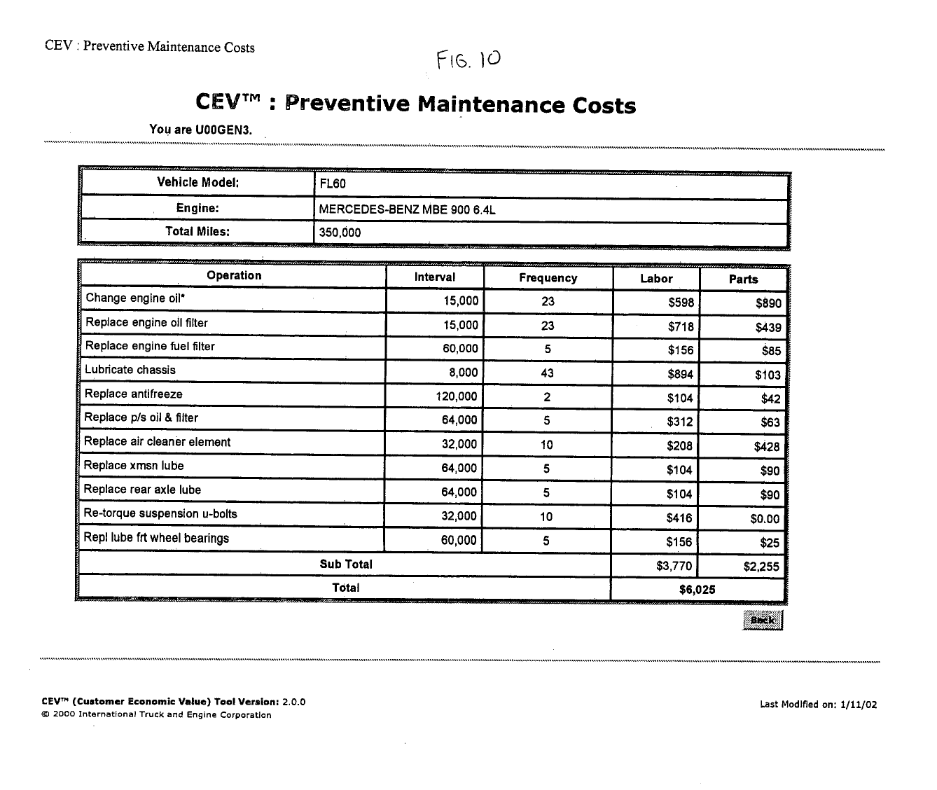

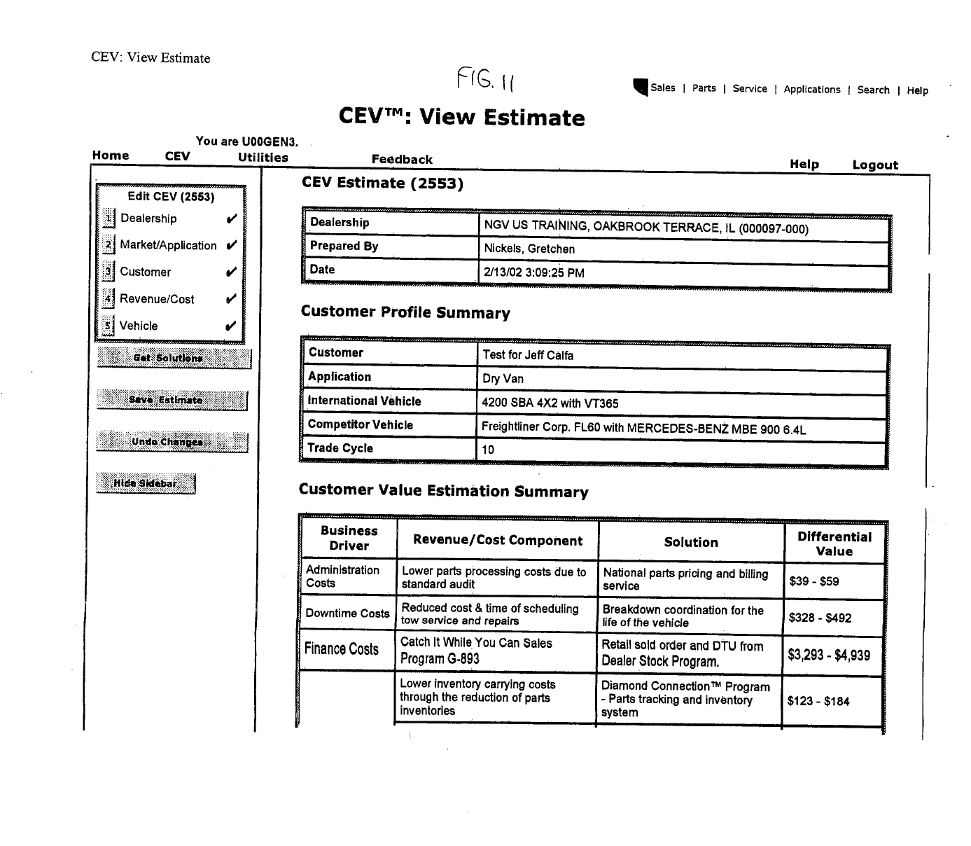

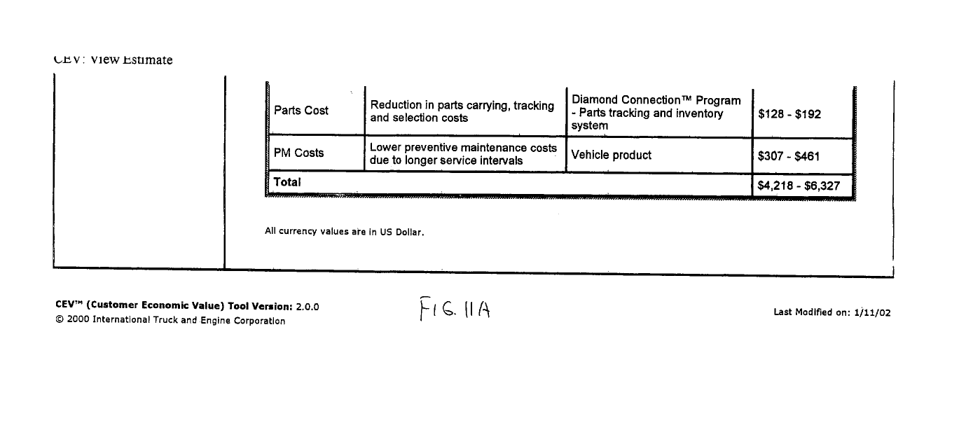

In Step 107, the system runs a comparison of the narrowed value, model, engine, warranty and other functionality solution to the selected competitor product and calculates a cost comparison. The output is derived from a table by table matrix comparison of potential services, engine overhaul requirements on the vehicles and engines being compared, resale values from tables using model and years and providing cross check values, and preventive maintenance costs based upon published manufacturers recommended service requirements. An example calculation details screen is shown in FIGS. 8 and 9. The narrowed value, model, engine, warranty and other functionality solution from the customer economic value tool is shown in one column against the selected competitor. FIG. 8 shows an example of the calculation steps and the description of the assumptions performed by the CEV tool for parts procurement. FIG. 9 shows an example of the calculation and assumptions performed by the CEV tool for preventive maintenance costs. FIG. 10 shows the assumptions for a competitor vehicle for the preventive maintenance steps. A user clicks to FIG. 10 through the screen of FIG. 9. FIGS. 11A and 11B show a view estimate for calculated cost differences between a narrowed value, model, engine, warranty and other functionality solution and a specific competitor.

FIG. 1 provides an overview of the steps of FIG. 12 in regards to the accessed data tables. The upper row of blocks is a highlight of the flow of logic steps 101 to 107 while the bottom row are pictorial representations of the accessed data tables for each step.

The process may be programmed into a computer or the program may be a computer program product comprised of a computer usable medium having computer readable program code means embodied in the medium for affecting the above process when used in conjunction with a computing system. It is envisioned that the computer could be either a portable laptop PC or personal digital assistant (PDA) that a sales representative could carry into a customer's facility and generate comparison models for customer comparisons. The medium could be an internal or external hard drive, a compact disc, floppy disc, zip drive or other suitable program medium.

As described above, the commercial vehicle customer economic value tool provide a number of advantages, some of which have been described above and others of which are inherent in the invention. Also modifications may be proposed to the commercial vehicle customer economic value tool with these components installed without departing from the teachings herein.

We claim:

1. A commercial vehicle customer economic value computer program product for use on a computer for assisting a customer in making a purchase decision, said computer program product comprising:
a computer useable medium having computer readable program code embodied in said medium for causing a computer with said medium loaded to generate a screen requesting a user to query and input the customers market or application;
computer readable program code for causing the computer to tie the application and type vehicle to a model and engine previously designed for that type business and application using a data matrix for solutions, and saving draft solutions with model and engine solution;
computer readable program code for causing the computer to request the user to query and input the customers' values or objectives when purchasing a commercial vehicle and narrowing results of model and engine solution with value and objective input to form a value objective narrowed model and engine solutions;
computer readable program code for causing the computer to request the user to query and input information related to the customer business' revenue and costs, and calculating customer specific vehicle use costs for customer to further narrow value objective narrowed model and engine solutions to form a revenue and cost based value objective narrowed model and engine solution;
computer readable program code for causing the computer to request the user to query and input the customers' needs for a vehicle in regards to warranty, and a need for a sleeping compartment and other functionality or service needs, and narrowing revenue and cost based value objective narrowed model and engine solution using warranty and other functionality preferences to generate a solution for a warranty and functionality revenue and cost based value objective narrowed model and engine solution for comparison to a competitor;
computer readable program code for causing the computer to generate a list of competitor products that were pre-determined to be analogous to a list of products that was narrowed down to the narrowed warranty and functionality revenue and cost based value objective narrowed model and engine solution and requesting the user select a specific competitor from this list for comparison and inputting the competitor for comparison; and
computer readable program code for causing the computer to generate a comparison solution with relative cost savings or negative differential between narrowed warranty and functionality revenue and cost based value objective narrowed model and engine solution and selected competitor.

2. The computer program product of claim 1, wherein said code for causing the computer to request the user to query and input the customers' values or objectives when purchasing a commercial vehicle is further comprised of comparing customer value and objective characteristics with a data table of value and objectives versus strategies and outputting customer strategies to the user.

3. The computer program product of claim 2, wherein said code for causing the computer to generate a comparison solution being derived from a table matrix comparison of potential services, engine overhaul requirements on vehicles and engines being compared, resale values from tables using model and years and providing cross check values, and preventive maintenance costs based upon published manufacturers recommended service requirements.

4. The computer program product of claim 3, comprising:
code for causing the computer to provide estimates on relative costs depending on whether the customer is financing or leasing the vehicle and providing on-screen result of each option within these choices.

5. A commercial vehicle customer economic value computer program product for use on a computer for assisting a customer in making a purchase decision, said computer program product comprising:
a computer useable medium having computer readable program code embodied in said medium for causing a computer with said medium loaded to generate a screen requesting a user to query and input the customers market or application;
computer readable program code for causing the computer to tie the application and type vehicle to a model and engine previously designed for that type business and application using a data matrix for solutions, and saving draft solutions with model and engine solution;
computer readable program code for causing the computer to request the user to query and input the customers' values or objectives when purchasing a commercial vehicle and narrowing results of model and engine solution with value and objective input to form a value objective narrowed model and engine solutions;
computer readable program code for causing the computer to request the user to query and input information related to the customer business' revenue and costs, and calculating customer specific vehicle use costs for customer to further narrow value objective narrowed model and engine solutions to form a revenue and cost based value objective narrowed model and engine solution for comparison to a competitor;
computer readable program code for causing the computer to generate a list of competitor products that were pre-determined to be analogous to a list of products that was narrowed down to the narrowed revenue and cost based value objective narrowed model and engine solution and requesting the user select a specific competitor from this list for comparison and inputting the competitor for comparison; and
computer readable program code for causing the computer to generate a comparison solution with relative cost savings or negative differential between narrowed revenue and cost based value objective narrowed model and engine solution and selected competitor.

6. A process for assisting a customer in making a purchase decision, comprising the steps of:
causing a computer to generate a screen requesting a user to query and input the customers market or application;
causing the computer to tie the application and type vehicle to a model and engine previously designed for that type business and application using a data matrix for solutions, and saving draft solutions with model and engine solution;
causing the computer to request the user to query and input the customers' values or objectives when purchasing a commercial vehicle and narrowing results of model and engine solution with value and objective input to form a value objective narrowed model and engine solutions;
causing the computer to request the user to query and input information related to the customer business' revenue and costs, and calculating customer specific vehicle use costs for customer to further narrow value objective narrowed model and engine solutions to form a revenue and cost based value objective narrowed model and engine solution;
causing the computer to request the user to query and input the customers' needs for a vehicle in regards to warranty, and a need for a sleeping compartment and other functionality or service needs, and narrowing revenue and cost based value objective narrowed model and engine solution using warranty and other functionality preferences to generate a solution for a warranty and functionality revenue and cost based value objective narrowed model and engine solution for comparison to a competitor;
causing the computer to generate a list of competitor products that were predetermined to be analogous to a list of products that was narrowed down to the narrowed warranty and functionality revenue and cost based value objective narrowed model and engine solution and requesting the user select a specific competitor from this list for comparison and inputting the competitor for comparison; and
causing the computer to generate a comparison solution with relative cost savings or negative differential between narrowed warranty and functionality revenue and cost based value objective narrowed model and engine solution and selected competitor.
